(19) United States
(12) Patent Application Publication
(10) Pub. No.: US 2024/0421531 A1
(43) Pub. Date: Dec. 19, 2024

(54) Connector

(71) Applicant: Tyco Electronics (Shanghai) Co., Ltd., Shanghai (CN)

(72) Inventors: Zhao Cheng, Shanghai (CN); Ming Shi, Shanghai (CN); Xiaozhi (George) Fu, Shanghai (CN); Dingbing (Frank) Fan, Shanghai (CN); Wei Zhang, Shanghai (CN)

(73) Assignee: Tyco Electronics (Shanghai) Co., Ltd., Shanghai (CN)

(21) Appl. No.: 18/740,898

(22) Filed: Jun. 12, 2024

(30) Foreign Application Priority Data
Jun. 13, 2023 (CN) 202310696584.X

(51) Int. Cl. H01R 13/533; H01R 12/77; H01R 13/42

(52) U.S. Cl. CPC H01R 13/533; H01R 12/778; H01R 13/42

(57) ABSTRACT

A connector includes a housing, multiple first terminals and a top cover. The housing defines multiple first terminal slots arranged and spaced in a transverse direction of the housing. The multiple first terminals are inserted into respective ones of the multiple first terminal slots. The top cover is installed on a top of the housing and is rotatably connected to the multiple first terminals. The top cover is rotatable between an opened position and a closed position.

### CROSS-REFERENCE TO RELATED APPLICATION

This application claims the benefit of Chinese Patent Application No. CN 202310696584.X filed on Jun. 13, 2023, in the State Intellectual Property Office of China, the whole disclosure of which is incorporated herein by reference.

### FIELD OF THE INVENTION

Embodiments of the present disclosure relate to a connector.

### BACKGROUND

A connector according to the prior art includes a housing, terminals, and a top cover. The terminals are installed in the housing. The top cover is installed on a top of the housing. In the prior art, terminals have no constraints or limitations on the top cover. In addition, the top cover and terminals are separated, and the top cover cannot apply pressing forces on the inserted circuit board arranged in the housing. In this way, the terminals can only rely on their own elastic force to make electrical contact with the inserted circuit board. As a result, in prior art connectors utilized in high vibration environments, the top cover is prone to detachment and poor contact between terminals and circuit board is more likely to occur.

### SUMMARY

According to an embodiment of the present disclosure, a connector includes a housing, multiple first terminals and a top cover. The housing defines multiple first terminal slots arranged and spaced in a transverse direction of the housing. The multiple first terminals are inserted into respective ones of the multiple first terminal slots. The top cover is installed on a top of the housing and is rotatably connected to the multiple first terminals. The top cover is rotatable between an opened position and a closed position.

### BRIEF DESCRIPTION OF THE DRAWINGS

The invention will now be described by way of example with reference to the accompanying Figures, of which:

FIG. 1 shows an illustrative perspective view of a connector according to an exemplary embodiment of the present invention, with the top cover in an open position;

FIG. 2 shows an illustrative perspective view of a connector according to an exemplary embodiment of the present invention, with the top cover in a closed position;

FIG. 3 shows an illustrative perspective view of a connector according to an exemplary embodiment of the present invention when viewed from the front side, with the top cover in a closed position;

FIG. 4 shows an illustrative exploded view of a connector according to an exemplary embodiment of the present invention, wherein the top cover is separated from the housing;

FIG. 5 shows an illustrative exploded view of a connector according to an exemplary embodiment of the present invention, wherein the top cover and terminals are separated from the housing;

FIG. 6 shows an illustrative perspective view of the first terminal of a connector according to an exemplary embodiment of the present invention;

FIG. 7 shows an illustrative perspective view of the second terminal of a connector according to an exemplary embodiment of the present invention;

FIG. 8 shows a longitudinal sectional view of a connector according to an exemplary embodiment of the present invention at the first terminal, with the top cover in the open position;

FIG. 9 shows a longitudinal sectional view of a connector according to an exemplary embodiment of the present invention at the first terminal, with the top cover in a closed position;

FIG. 10 shows a longitudinal sectional view of a connector according to an exemplary embodiment of the present invention at the second terminal, with the top cover in the open position; and

FIG. 11 shows a longitudinal sectional view of a connector according to an exemplary embodiment of the present invention at the second terminal, with the top cover in a closed position.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth to provide a thorough understanding of the disclosed embodiments. It will be apparent, however, that one or more embodiments may be practiced without these specific details. In other instances, well-known structures and devices are schematically shown to simplify the drawing.

According to an embodiment of the present disclosure, a connector comprises: a housing formed with multiple first terminal slots arranged and spaced in its transverse direction; multiple first terminals inserted into the multiple first terminal slots; and a top cover installed on a top of the housing. The top cover is rotationally connected to multiple first terminals, allowing the top cover to be rotatably opened and closed.

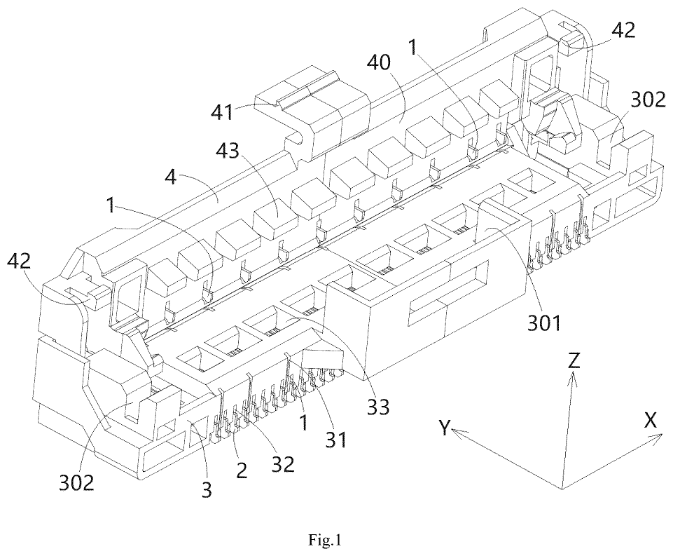

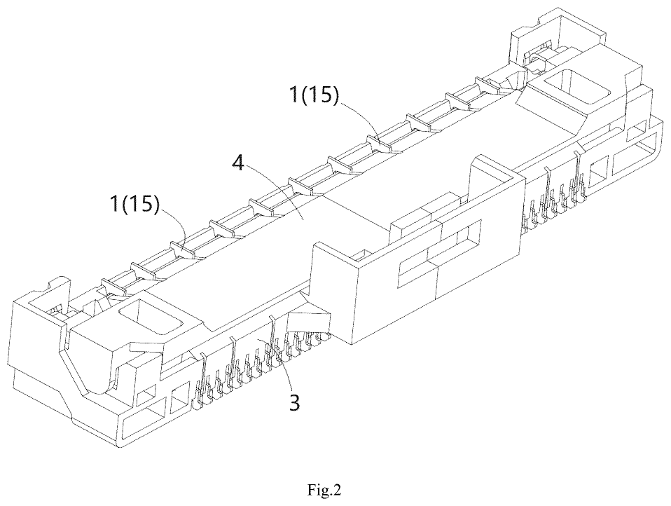

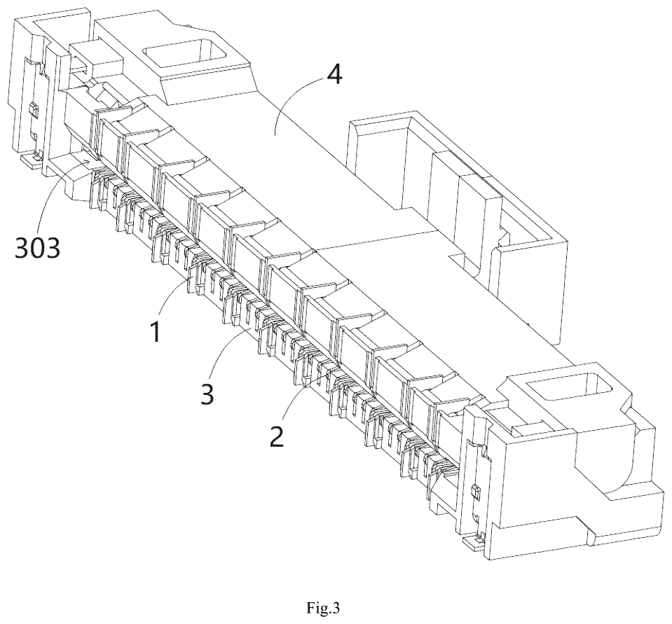

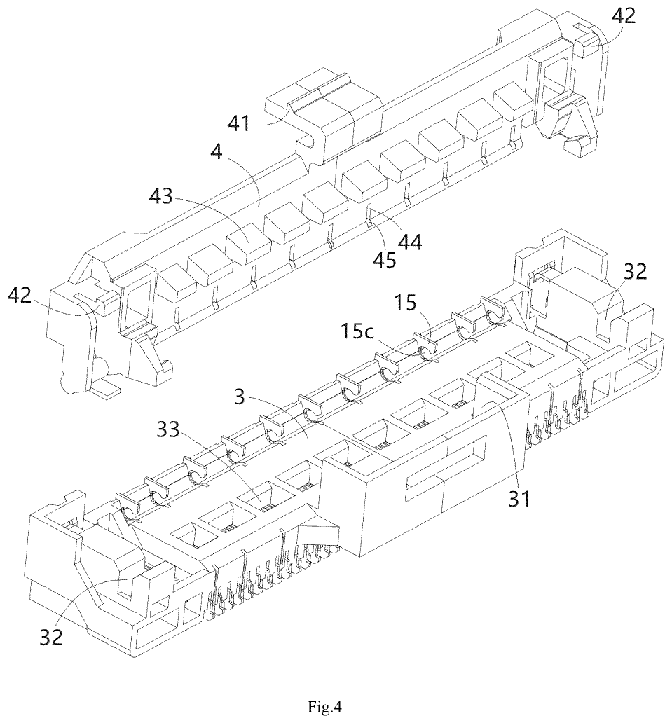

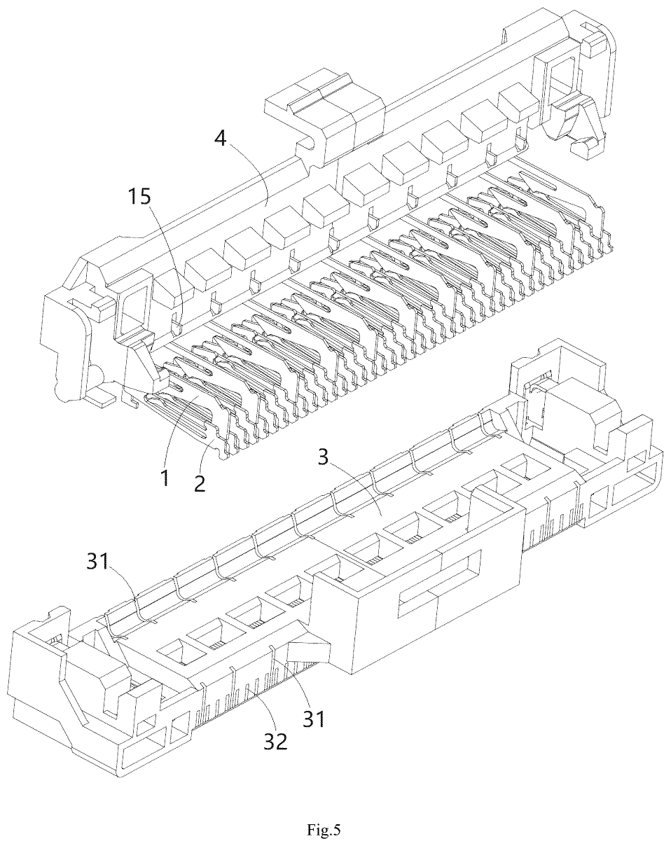

FIG. 1 shows an illustrative perspective view of a connector according to an exemplary embodiment of the present invention, with a top cover in the open position. FIG. 2 shows an illustrative perspective view of a connector according to an exemplary embodiment of the present invention, wherein the top cover is in a closed position. FIG. 3 shows an illustrative perspective view of a connector according to an exemplary embodiment of the present invention when viewed from the front side, with the top cover in a closed position. FIG. 4 shows an illustrative exploded view of a connector according to an exemplary embodiment of the present invention, wherein the top cover is separated from the housing 3. FIG. 5 shows an illustrative exploded view of a connector according to an exemplary embodiment of the present invention, wherein the top cover and the terminals are separated from the housing.

As shown in FIGS. 1-5, in an exemplary embodiment of the present invention, a connector is disclosed. The connector mainly includes a housing 3, multiple first terminals 1, and a top cover 4. Multiple first terminal slots 31 are formed in the housing 3. The first terminal slots 31 are arranged and spaced in a transverse direction X of the housing 3. Multiple first terminals 1 are inserted into respective ones of the multiple first terminal slots 31. The top cover 4 is installed on a top of the housing 3. The top cover 4 is rotatably connected to the multiple first terminals 1, allowing the top cover 4 to be rotatably opened and closed.

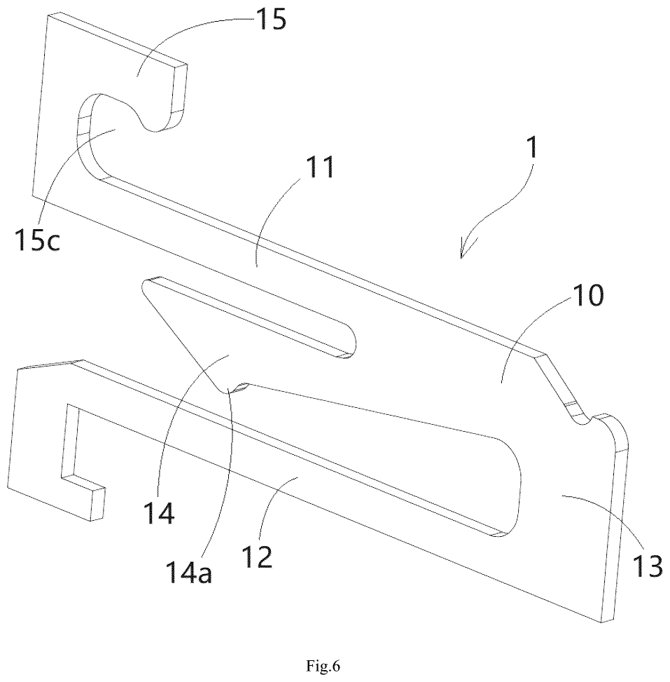

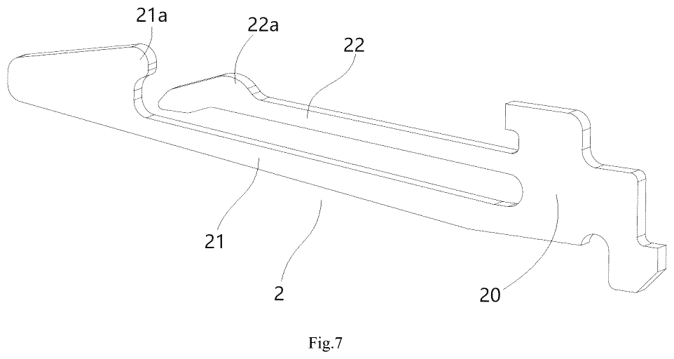

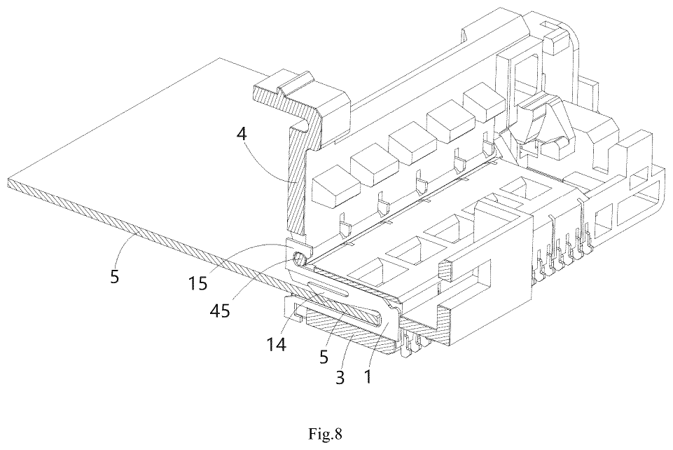

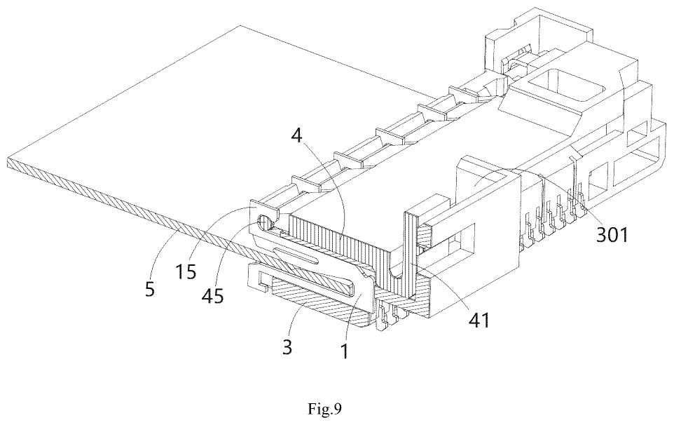

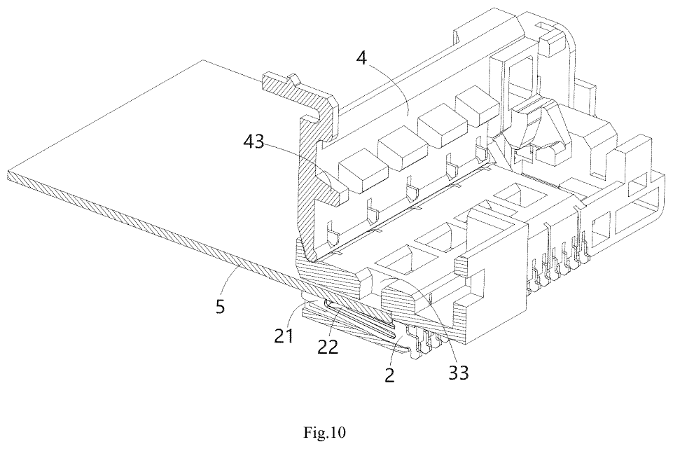

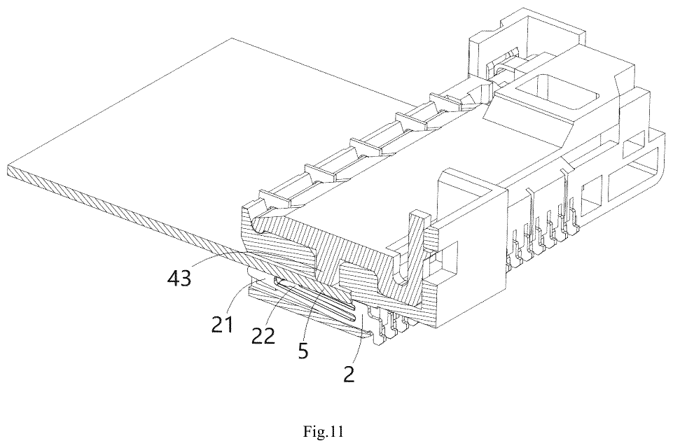

FIG. 6 shows an illustrative perspective view of the first terminal of a connector according to an exemplary embodiment of the present invention. FIG. 7 shows an illustrative perspective view of a second terminal of a connector according to an exemplary embodiment of the present invention. FIG. 8 shows a longitudinal sectional view of a connector according to an exemplary embodiment of the present invention at the first terminal, with the top cover in the opened position. FIG. 9 shows a longitudinal sectional view of a connector according to an exemplary embodiment of the present invention at the first terminal, with the top cover in a closed position. FIG. 10 shows a longitudinal sectional view of a connector according to an exemplary embodiment of the present invention at the second terminal, with the top cover in the opened position. FIG. 11 shows a longitudinal sectional view of a connector according to an exemplary embodiment of the present invention at the second terminal, with the top cover in a closed position.

As shown in FIGS. 1-11, in the illustrated embodiments, multiple second terminal slots 32 are also formed in the housing 3. The multiple second terminal slots 32 are arranged and spaced in the transverse direction X. The connector also includes multiple second terminals 2 inserted into respective ones of the multiple second terminal slots 32.

A circuit board slot 303 for inserting a circuit board 5 is also formed in the housing 3. The circuit board slot 303 extends in the transverse direction X and the longitudinal direction Y of the housing 3. The circuit board slot 303 is communicated with the multiple first terminal slots 31 and the multiple second terminal slots 32.

The connector further comprises a circuit board 5 inserted into the circuit board slot 303. The circuit board 5 electrically contacts the multiple first terminals 1 and the multiple second terminals 2. In an exemplary embodiment of the present invention, the circuit board 5 may be a flexible printed circuit board (FPC).

Multiple openings 33 in communication with the circuit board slot 303 are formed through a top wall of the housing 3. Multiple protrusions 43 corresponding to the multiple openings 33 are formed on the top cover 4. When the top cover 4 is closed, the protrusions 43 are inserted into respective ones of the openings 33. The protrusions 43 are adapted to apply a predetermined pressing force on the circuit board 5 to ensure reliable electrical contact between the circuit board 5 and the second terminals 2.

In the illustrated embodiment, the multiple first terminal slots 31 and the multiple second terminal slots 32 are arranged in a row along the transverse direction X of the housing 3. The first terminal slots 31 and the second terminal slots 32 extend along the longitudinal direction Y and the height direction Z of the housing 3. In the exemplary embodiment, there is at least one second terminal slot 32 between any two adjacent first terminal slots 31, so that there is at least one second terminal 2 between any two adjacent first terminals 1.

As shown in FIGS. 1 to 11, in the illustrated embodiment, each of the multiple first terminals 1 includes a connecting part 15, which is exposed from the top wall of the housing 3 and rotatably connected to one side of the top cover 4. A C-shaped snap slot 15c is formed on the connecting part 15. An insertion slot 44 is formed on one side of the top cover 4. The top cover 4 has a pivot shaft 45 connected between a pair of inner walls of the insertion slot 44. The connecting part 15 is inserted into the insertion slot 44 of the top cover 4, and the pivot shaft 45 is rotatably engaged in the C-shaped snap slot 15c. Accordingly, the top cover 4 can rotate around the central axis of the pivot shaft 45.

Each of the multiple first terminals 1 further comprises a first fixing part 10 and a cantilever portion 14. The first fixing part 10 is fixed in the first terminal slot 31, for example, through an interference fit. The cantilever portion 14 is connected to the first fixing part 10 and suspended in the first terminal slot 31. A contact protrusion 14a is formed on the end of the cantilever 14, which is used for electrical contact with the circuit board 5.

The first fixing part 10 comprises an upper support arm 11, a lower support arm 12, and a connecting arm 13. The connecting arm 13 is connected between the rear ends of the upper support arm 11 and the lower support arm 12. The connecting part 15 is connected to the front end of the upper support arm 11.

Each of the multiple second terminals 2 comprises a second fixing part 20 and a first cantilever portion 21. The second fixing part 20 is fixed in the second terminal slot 32, for example, through an interference fit. The first cantilever portion 21 is connected to the second fixing part 20 and suspended in the second terminal slot 32. A first electrical contact 21a is formed on the first cantilever portion 21, which is used for electrical contact with the inserted circuit board 5.

In the illustrated embodiment, the second terminal 2 further comprises a second cantilever portion 22. The second cantilever portion 22 is connected to the second fixing part 20 and suspended in the second terminal slot 32. A second electrical contact 22a is formed on the second cantilever portion 22, which is used for electrical contact with the inserted circuit board 5. The first electrical contact 21a and the second electrical contact 22a are spaced from each other in the longitudinal direction Y of the housing 3. The first cantilever portion 21 is located below the second cantilever portion 22.

The top cover 4 comprises a cover plate 40 and an elastic buckle 41, 42. The elastic buckle 41, 42 is formed on the cover plate 40. A snap slot 301, 302 is formed on the housing 3 for engaging with the elastic buckle 41, 42 to lock the top cover 4 in a closed position. The cover plate 40 has a first side and a second side opposite to each other in its width direction. The first side of the cover plate 40 is rotatably connected to multiple first terminals 1, and the elastic buckle 41, 42 is formed at the second side of the cover plate 40.

The elastic buckle 41, 42 includes a first elastic buckle 41, which is located in the middle position in the length direction of the cover plate 40. The snap slot 301, 302 includes a first snap slot 301, which is located in the middle position of the transverse direction X of the housing 3 and is used to engage with the first elastic buckle 41. The elastic buckles 41, 42 further includes a pair of second elastic buckles 42, which are respectively located at both ends of the length direction of the cover plate 40. The snap slot 301, 302 also includes a pair of second snap slots 302, which are respectively located at the two ends of the transverse direction X of the housing 3, for engagement with the pair of second elastic buckles 42.

In the illustrated embodiment, the multiple first terminals 1 are the grounding terminals, and the multiple second terminals 2 are the signal terminals. In this way, the top cover is rotated and connected to the grounding terminals, so that the top cover will not fall off the housing due to vibration. In addition, the top cover can also apply a predetermined pressing force between the circuit board and the signal terminals, ensuring reliable electrical contact between the circuit board and the signal terminals.

In addition, those areas in which it is believed that those of ordinary skill in the art are familiar, have not been described herein in order not to unnecessarily obscure the invention described. Accordingly, it must be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector, comprising:
a housing defining multiple first terminal slots arranged and spaced in a transverse direction of the housing;
multiple first terminals inserted into respective ones of the multiple first terminal slots; and
a top cover installed on a top of the housing and rotatably connected to the multiple first terminals, the top cover rotatable between an opened position and a closed position.

2. The connector according to claim 1, further comprising multiple second terminals inserted into respective multiple second terminal slots formed in the housing and spaced in the transverse direction.

3. The connector according to claim 2, wherein the housing defines a circuit board slot adapted to receive a circuit board and extending in the transverse direction and a longitudinal direction of the housing, the circuit board slot in communication with the multiple first terminal slots and the multiple second terminal slots.

4. The connector according to claim 3, further comprising a circuit board inserted into the circuit board slot and electrically contacting the multiple first terminals and the multiple second terminals.

5. The connector according to claim 4, wherein the circuit board is a flexible printed circuit board.

6. The connector according to claim 3, wherein:
a top wall of the housing defines multiple openings in communication with the circuit board slot;
multiple protrusions corresponding to the multiple openings are formed on the top cover; and
when the top cover is in the closed position, the multiple protrusions are inserted into the multiple openings and are adapted to apply a predetermined pressing force on the circuit board to ensure reliable electrical contact between the circuit board and the second terminals.

7. The connector according to claim 2, wherein:
the multiple first terminal slots and the multiple second terminal slots are arranged in a row along the transverse direction of the housing; and
the first terminal slots and the second terminal slots extend along a longitudinal direction and a height direction of the housing.

8. The connector according to claim 7, wherein there is at least one second terminal slot between any two adjacent first terminal slots, so that there is at least one second terminal between any two adjacent first terminals.

9. The connector according to claim 3, wherein each of the first terminals includes a connecting part exposed from the top wall of the housing and rotatably connected to one side of the top cover.

10. The connector according to claim 9, wherein:
a C-shaped snap slot is formed on the connecting part, an insertion slot is formed on one side of the top cover, and the top cover has a pivot shaft connected between a pair of inner walls of the insertion slot; and
the connecting part is inserted into the insertion slot of the top cover, and the pivot shaft is rotatably engaged in the C-shaped snap slot, so that the top cover can rotate around the central axis of the pivot shaft.

11. The connector according to claim 9, wherein each of the first terminals further includes:
a first fixing part which is fixed in the first terminal slot; and
a cantilever portion which is connected to the first fixing part and suspended in the first terminal slot, a contact protrusion is formed on the end of the cantilever portion and is adapted to electrically contact the circuit board.

12. The connector according to claim 11, wherein the first fixing part includes:
an upper support arm;
a lower support arm; and
a connecting arm connected between rear ends of the upper support arm and the lower support arm, the connecting part is connected to a front end of the upper support arm.

13. The connector according to claim 3, wherein each of the second terminals includes:
a second fixing part fixed in the second terminal slot; and
a first cantilever portion connected to the second fixing part and suspended in the second terminal slot, a first electrical contact is formed on the first cantilever portion, and is adapted to electrically contact the inserted circuit board.

14. The connector according to claim 13, wherein each of the second terminals further includes a second cantilever portion connected to the second fixing part and suspended in the second terminal slot, a second electrical contact is formed on the second cantilever portion and is adapted to electrically contact the inserted circuit board.

15. The connector according to claim 14, wherein the first electrical contact and the second electrical contact are spaced from each other in the longitudinal direction of the housing, and the first cantilever portion is located below the second cantilever portion.

16. The connector according to claim 1, wherein the top cover includes:
a cover plate; and
an elastic buckle formed on the cover plate, a snap slot is formed on the housing and engages with the elastic buckle, so as to lock the top cover in the closed position.

17. The connector according to claim 16, wherein the cover plate has a first side and a second side opposite to each other in its width direction, the first side of the cover plate is rotatably connected to the multiple first terminals, and the elastic buckle is formed at the second side of the cover plate.

18. The connector according to claim 17, wherein:
the elastic buckle includes a first elastic buckle located in the middle position in a length direction of the cover plate; and
the snap slot includes a first snap slot located in a middle position of the transverse direction of the housing and adapted to engage with the first elastic buckle.

19. The connector according to claim 18, wherein:
the elastic buckle further includes a pair of second elastic buckles located at both ends in the length direction of the cover plate, respectively; and
the snap slot further includes a pair of second snap slots located at both ends of the transverse direction of the housing, respectively, for engaging with the pair of second elastic buckles.

20. The connector according to claim 2, wherein the multiple first terminals are grounding terminals, and the multiple second terminals are signal terminals.
